(19) United States
(12) Patent Application Publication
(10) Pub. No.: US 2015/0369432 A1
(43) Pub. Date: Dec. 24, 2015

(54) ELECTRIC CANDLE WITH ILLUMINATING PANEL

(71) Applicant: Xiaofeng Li, Shenzhen (CN)

(72) Inventor: Xiaofeng Li, Shenzhen (CN)

(21) Appl. No.: 14/594,318

(22) Filed: Jan. 12, 2015

Related U.S. Application Data
(63) Continuation-in-part of application No. 14/449,865, filed on Aug. 1, 2014.
Application No. 14/449,865 is a continuation-in-part of application No. PCT/CN2014/087931, filed on Sep. 30, 2014.

(30) Foreign Application Priority Data
Jun. 24, 2014 (CN) 201420342430

(51) Int. Cl. F21S 6/00; F21V 23/00; F21S 10/04

(52) U.S. Cl. CPC F21S 6/001; F21S 10/046; F21S 10/043; F21V 23/003; F21Y 2105/001

(57) ABSTRACT

The present disclosure, in one embodiment, relates to an electric flameless candle, comprising a body configured in shape and size to simulate a true flame candle. The electric flameless candle further comprising a light source operably connected to the body and positioned to be generally protruding from an exterior surface of the body, the light source comprising a plurality of illuminators electrically operated to illuminate in a way that simulates the movement of a real candle's flame.

### CROSS-REFERENCE TO RELATED APPLICATIONS

This application claims the benefit of Chinese Patent Application No. 201420342430, filed on Jun. 24, 2014, entitled “A Simulated Flame Lighting Device,” is a continuation-in-part of U.S. patent application Ser. No. 14/449,865, filed on Aug. 1, 2014, entitled “Electronic Candle with Illuminating Panel,” and is a continuation-in-part of PCT/CN2014/087931, filed Sep. 30, 2014, the disclosures of which are hereby incorporated by reference herein in their entirety.

### FIELD OF THE INVENTION

The present disclosure relates to novel and advantageous flameless electric candles. Particularly, the present disclosure relates to electric candles simulating a realistic flame of a true flame candle.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditional true flame candles, when lit, provide a pleasant ambience in many homes, hotels, churches, businesses, etc. Traditional candles however, provide a variety of hazards including risk of fire, damage to surfaces caused by hot wax, and the possible emission of soot. Flameless candles have become increasingly popular alternatives to traditional candles. With no open flame or hot melted wax, flameless candles provide a longer-lasting, safe, and clean alternative. There are flameless candles available that use light emitting diodes (LEDs) as a light source. However, such flameless candles do not provide a natural looking and light emitting light source that may simulate the natural flicker and movements of a flame.

Thus, there is a need in the art for a candle that is aesthetically similar to a traditional candle. More particularly, there is a need for a flameless candle that emits a light that simulates the more natural, flame-like flicker and movement of light found in traditional candles.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to an electric flameless candle, comprising a body configured in shape and size to simulate a true flame candle. The electric flameless candle further comprising a light source operably connected to the body and positioned to be generally protruding from an exterior surface of the body, the light source comprising a plurality of illuminators electrically operated to illuminate in a way that simulates the movement of a real candle's flame.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a cross-section of a flameless pillar candle, according to an embodiment of the present disclosure.

FIG. 2 is a perspective view of a luminous panel, according to an embodiment of the present disclosure.

FIG. 3 is an exploded perspective view of a flameless pillar candle, according to an embodiment of the present disclosure.

FIG. 4A is a cross-section of a flameless pillar candle, according to another embodiment of the present disclosure.

FIG. 4B is a close-up cross-section of a portion of a flameless pillar candle, according to an embodiment of the present disclosure.

FIG. 5A is a cross-section of a flameless pillar candle, according to another embodiment of the present disclosure.

FIG. 5B is an exploded perspective view of a lifting mechanism, according to an embodiment of the present disclosure

FIG. 6 is a perspective view of a flameless pillar candle, according to an embodiment of the present disclosure.

FIG. 7 is a perspective view of a flameless light bulb, according to another embodiment of the present disclosure.

FIG. 8 is an exploded perspective view of a flameless light bulb, according to an embodiment of the present disclosure.

FIG. 9 is a perspective view of a flameless light bulb, according to another embodiment of the present disclosure.

FIG. 10 is an exploded perspective view of a flameless light bulb, according to an embodiment of the present disclosure.

FIG. 11A is a schematic of some components of a flameless candle or light bulb, according to an embodiment of the present disclosure.

FIG. 11B is another schematic of some components of a flameless candle or light bulb, according to an embodiment of the present disclosure.

FIG. 11C is yet another schematic of some components of a flameless candle or light bulb, according to another embodiment of the present disclosure.

FIG. 12 is a cross-section of a flameless pillar candle, according to another embodiment of the present disclosure.

FIG. 13 includes front, side, and rear views of a luminous panel, according to an embodiment of the present disclosure.

FIG. 14 is an exploded perspective view of a flameless pillar candle, according to an embodiment of the present disclosure.

FIG. 15 is an exploded perspective view of a flameless pillar candle, according to another embodiment of the present disclosure.

FIG. 16 is a perspective view of a flameless pillar candle, according to an embodiment of the present disclosure.

FIG. 17 is a perspective view of a luminous panel, according to an embodiment of the present disclosure.

FIG. 18 is a cross-section of a flameless pillar candle, according to another embodiment of the present disclosure.

FIG. 19 is an exploded perspective view of a flameless light bulb, according to an embodiment of the present disclosure.

FIG. 20 is a perspective view of a flameless light bulb, according to an embodiment of the present disclosure.

### DETAILED DESCRIPTION

The present disclosure relates to novel and advantageous flameless candles. Particularly, the present disclosure relates to novel and advantageous flameless candles simulating a realistic flame on a LED panel or matrix.

The present disclosure relates to a flameless candle and flameless light that uses a LED light source to provide the appearance of a natural flame and flame-like flicker of light. The flameless candle may include a body having a top surface, a bottom surface upon which the body rests, and a sidewall between the bottom surface and the top surface. In another embodiment, the flameless candle may include a body having a bulb like cover and a mounting base or end cap, which may, in some embodiments, connect to a traditional light socket. One or more control switches may be used to provide a variety of functions when activated separately or together, including but not limited to, turning the light source ON or OFF, operating the light source in a static or dynamic flame mode, adjusting the size of the flame, changing the color of the light, dimming or brightening of the light source, displaying one or more varying images or light configurations, adjusting the position of a luminous panel, or operating a timer. The simulated flame may be created by lights positioned on the luminous panel. In at least one embodiment, the luminous panel may raise or lower out of the body of the candle when activated or deactivated. The lights, or illuminators, on the luminous panel may be in electrical communication with a circuit board which may provide one or more signals to the lights. In various embodiments, a signal or signals may control which lights on the luminous panel are turned ON in order to simulate the appearance of a flame, or any other desired image or configuration of lights. In some embodiments, a signal or the signals may be comprised of random frequencies and amplitudes of current. The circuit board may also control pulse-width modulation and the frequency and duty ratio of the signal(s) received by the light. The signal(s) transmitted randomly to one or more of the LED lights on the luminous panel may cause the LEDs to produce what appears to be a natural flame which has a natural “flicker” of light to the human eye, in accordance with one embodiment of the present disclosure.

The Flameless Candle

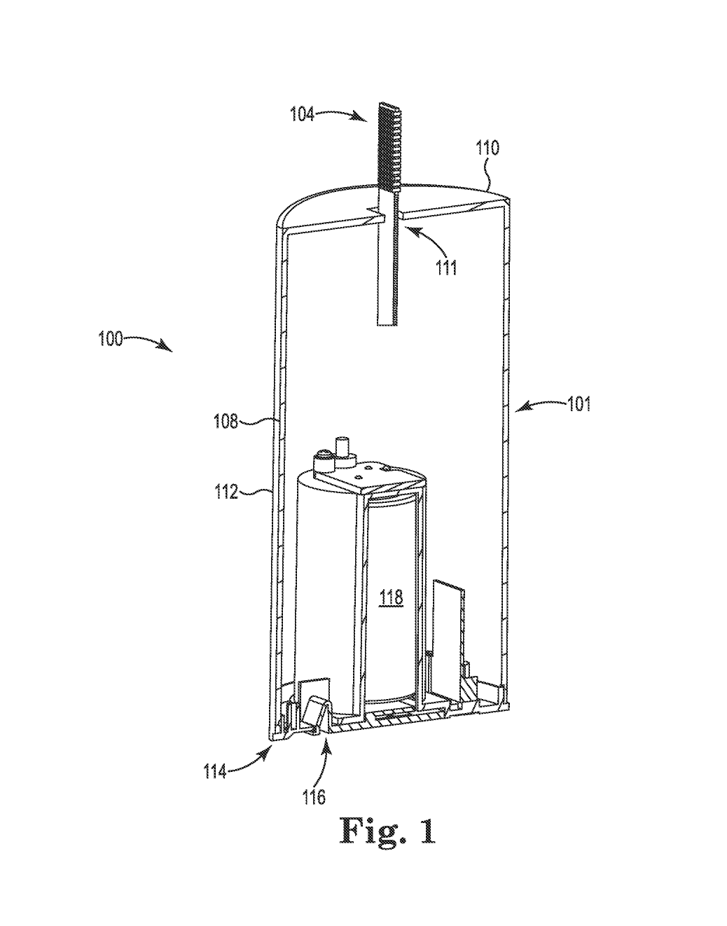

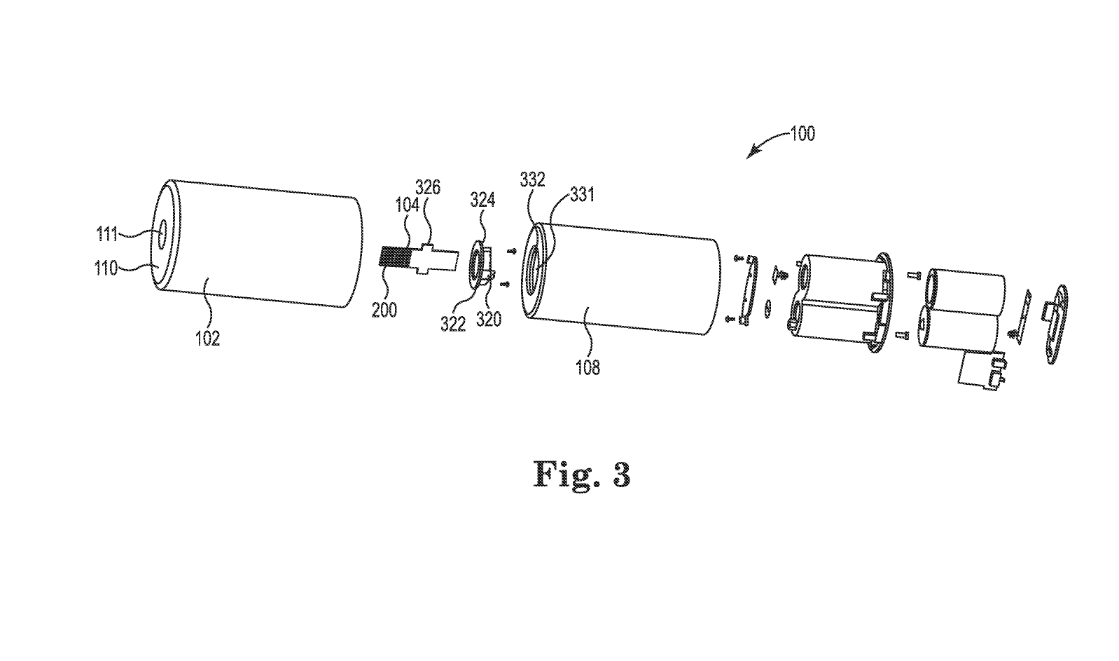

The flameless candles described herein may provide a realistic flame-like light from a light source. In this regard, a flameless candle of the present disclosure may be comprised of one or more components that may function to mimic a natural flame and, additionally or alternatively, a flame-like flicker of light. Referring to FIGS. 1 and 3, a flameless candle 100 may be comprised of a candle shaped shell 101, a luminous panel 104, and a control panel. In some embodiments, the candle shaped shell 101 may comprise one or both of a shell body 102 and an inner base or mounting base 108. In various embodiments, the mounting base 108 and/or body 102 may be used to mount a lifting mechanism, which may raise or lower the luminous panel 104 into and/or out of the shell 101.

Structure

The Body

Generally, as illustrated in the flameless pillar candle of FIGS. 1 and 3, the shell 101 and/or body 102 may be comprised of a top surface 110, a bottom surface 114 upon which the candle rests, and a sidewall 112 between the top surface 110 and bottom surface 114. The body 102 may have desirable translucent, luminescent, and aesthetic properties to mimic the look and feel of a traditional candle. The body 102 may be made from one or more materials, including but not limited to, wax, paraffin, glass, polymeric materials, or any combination thereof. In some embodiments, the body 102 may be configured to have a cylindrical shape, thereby resembling a traditional pillar candle, as shown. However, other shapes or configurations are possible and within the scope of the disclosure including, but not limited to, a cube, cuboid, cone, pyramid, sphere, any other traditional shape, or any custom shape.

The top surface 112 may generally refer to the top portion of the candle. The top surface 112 may include one or more structural components. In various embodiments, the top surface 112 may include a through-hole or slot 111 through which the luminous panel 104 may extend, thereby protruding from an exterior surface of the body 102. In some embodiments, the top surface may be a substantially flat surface. In other embodiments, the top surface may have an indented central portion that may resemble the top surface of a used or partially melted traditional candle, where the wax may have been reduced by melting from the heat of the open flame in order to continue feeding the flame. The bottom surface 114 may generally be flat, resulting in a stable condition of the candle when placed on a table, shelf or other suitable flat surface. The bottom surface 114 may also include a removable or repositionable cover 116, which may allow easy access to a power supply 118. In addition, the bottom surface 114 may include one or more control switches, which may activate and/or deactivate one or more functions presented herein.

The Luminous Panel

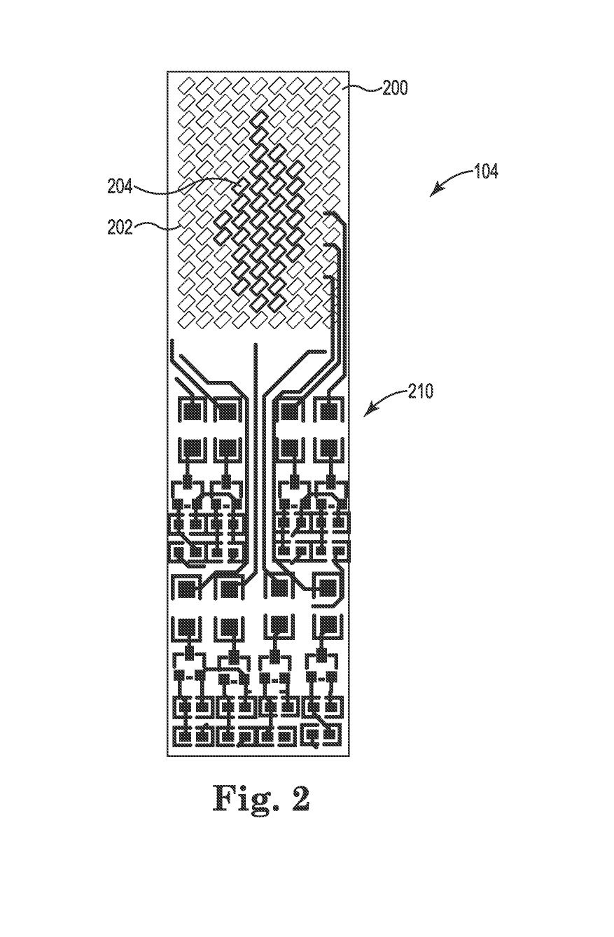

As illustrated in FIG. 1, one or more luminous panels 104 may be disposed in the center of the top surface 110 of the candle 100. The luminous panel 104 may have one or more components that are adapted to simulate a candle wick and/or flame. In one embodiment, seen in FIG. 2, the luminous panel 104 may be comprised of a display panel 200 and a control panel 210. In other embodiments, the control panel 210, or control circuit, may or may not be formed on the luminous panel 104, but may nonetheless remain in electrical communication with one or more illuminators. A plurality of illuminators 202, 204 may be located on the display panel 200, which may be located on a top or upper portion of the luminous panel 104, such that they may be exposed external to the body 102 of the candle 100.

In some embodiments, the illuminators may be arranged on a display panel 200 in an organized manner. In various embodiments, as seen in FIG. 2, the illuminators 202, 204 may be formed in rows and/or columns to generally form a matrix. In some embodiments, the individual illuminators 202, 204 may be positioned or aligned such that they are tilted or angled, in perspective to a vertical axis of the candle. In another embodiment, the illuminators 202, 204 may be arranged perpendicular to the vertical axis of the candle. In still another embodiment, the illuminators 202, 204 may be arranged parallel, or substantially vertically aligned with, the vertical axis of the candle. In still another embodiment, there may be no defined order to the placement of one or more illuminators, i.e., a random arrangement. It may be appreciated that any suitable arrangement, or combination thereof, may be used to orient one or more illuminators on the display panel 200.

In one embodiment, the luminous panel 104 may include one display panel 200. In another embodiment, the luminous panel 104 may have two display panels 200, such that both sides, or multiple sides, of the luminous panel 104 may have a display panel 200. In still other embodiments, the luminous panel 104 and one or more display panel(s) 200 may cooperate to form other shapes. For example, three display panels 200 may be used to form a triangle, such that a display panel may be viewable from even more angles. In still another example, four display panels 200 may be used to form a square or cube. In yet another example, a luminous panel 104 and/or display panel 200 may be curved or cylindrical in shape, such that the display panel 200 may be generally visible in a 360 degree perspective. In at least one embodiment, the illuminators may be comprised of one or more LEDs. In other embodiments, any suitable light or bulb may be additionally or alternatively used. In one embodiment, the illuminators 202, 204 may be rectangular bulbs or lights. In another embodiment, the illuminators 202, 204 may be square shaped. In still another embodiment, the illuminators 202, 204 may be circular shaped. It may be appreciated that any suitable shape for the illuminators 202, 204 may be used. In addition, the illuminators may be the same or different colors. In some embodiments, each illuminator may be capable of illuminating in one or more colors, including but not limited to, white, orange, red, yellow, blue, purple, green, any other suitable color, or any combination thereof.

The one or more display panels 200 may also be comprised of any size, shape, or color. In one embodiment, as illustrated in FIG. 2, the display panel 200 of luminous panel 104 may be generally rectangular in shape. In other embodiments, the display panel 200 may be circular, square or cube, or any other suitable shape. In still others, the display panel 200 may be generally shaped like a flame or otherwise have attributes that appear flame-like. In some embodiments, the display panel 200 may be black in color, especially when the illuminators 202, 204 are turned OFF, so as to simulate a natural wick. In other embodiments, the display panel 200 may be any suitable color. In still other embodiments, the display panel 200 may be substantially clear or transparent, or semi-transparent.

In addition, the thickness of the display panel 200 may be relatively thin in order to simulate the impression of a natural wick. In at least one embodiment, the thickness of the display panel 200 may be approximately 0.4 mm. In other embodiments, the thickness of the display panel 200 may be between 0.6 mm and 0.2 mm. In still other embodiments, the thickness of the display panel 200 may range from 1.0 mm to 0.1 mm. However, in some embodiments, it may be preferable to have a display panel 200 with a thickness of greater than 1.0 mm or less than 0.1 mm. As may be appreciated, any suitable thickness for the display panel 200 may be used.

The Mounting Base

In various embodiments, the luminous panel 104 may be mechanically connected or mounted to the candle body 102 and/or mounting base 108. In some embodiments, the mounting base 108 may be similar in design to the body 102, such that the mounting base 108 may fit into the body 102, seen in detail in the exploded view of FIG. 3. In other embodiments, just one of the body 102 or base 108 may be used or, the candle body 102 and mounting base 108 may be the same or similar structures. In some embodiments, the mounting base 108 may be comprised of one component, such as a mold designed to mimic the shape of the body 102, as seen in FIG. 3. In other embodiments, the mounting base 108 may be comprised of one, two, or more components, which join together to generally the same shape as the body 102. In embodiments where the mounting base 108 is comprised of two or more components, the components may be clamped together. For example, in one embodiment, the mounting base 108 may be comprised of two generally symmetrical halves that connect, snap, or otherwise fit together to form the completed mounting base form. As should be appreciated, the two or more components may be connected using any suitable method, including but not limited to, friction fit, bayonet fit, snap fit, threaded, affixed using an adhesive or screw, any other suitable method, or any combination thereof. The mounting base 108 and other internal components, such as but not limited to the mounting pad 320 described below, may be comprised of a substantially transparent or semi-transparent material, which may allow illumination, or enhanced illumination, of the body 102.

In various embodiments, the luminous panel 104 may be mechanically connected or mounted to the candle body 102 and/or mounting base 108, such that it may be generally non-moveable. In one embodiment shown in exploded FIG. 3, the mounting base 108 may include a through-hole 331. In one embodiment, the through-hole 331 may be circular. In another embodiment, the through-hole 331 may be square shaped. It may be understood that any suitable shape for the through-hole 331 may be used. The through-hole 331 of mounting base 108 may be the same size as the through-hole 111 of body 102. In other embodiments, the through-hole 331 of mounting base 108 may be smaller or larger than the through-hole 111 of body 102. In various embodiments, the through-hole 331 of mounting base 108 and the through-hole 111 of body 102 may cooperate to form an opening such that a sleeve or slot may be provided in which the luminous panel 104 may pass through or sit-in. In various embodiments, the through-hole 331 may comprise one or more indented levels or grooves 332.

In some embodiments, a mounting pad 320 may be used to, directly or indirectly, secure the luminous panel. The mounting pad 320 may generally connect or mesh with and/or rest on the top surface of the mounting base 108 and or rest in one of the one or more grooves 332 of the mounting base 108, such that it may not fall below the top surface of the mounting base 108. The mounting pad 320 may include a shoulder 322. In various embodiments, the shoulder 322 of the mounting pad 320 may be positioned over a limit level or groove 332 of the mounting base 108, thereby becoming generally embedded in the groove 332 and through-hole 331. In various embodiments, the mounting pad 320, when embedded or positioned within the groove 332 may become flush with the top of the mounting base 108. In various embodiments, the mounting pad 320 may also include one or more locating slots 324, or similar feature. The locating slots 324 may cooperate with one or more corresponding or mating features of the mounting base 108 in order to snap or slide into one or more predetermined optimal positions, thereby connecting or meshing the mounting pad 320 to the mounting base 108. In various embodiments, the locating slots 324 may, additionally or alternatively, be used to connect the luminous panel 104 to the mounting pad 320.

The luminous panel 104 may have one or more protruding arms, or stoppers 326. The one or more stoppers 326 of the luminous panel 104 may generally and substantially align with the one or more locating slots 324 of the mounting pad 320. Once the stoppers 326 are aligned in the locating slots 324, the luminous panel 104 may be stopped, or generally prevented from lowering further into the body of the candle, which may allow the display panel 200 to be generally viewable from the exterior of the candle body 102. In at least one embodiment, the luminous panel 104 may have no protruding arms or stoppers 326, and other means or methods for connecting the luminous panel to the body 102 and/or base 108, such as friction fit, snap fit, bayonet connection, adhesive, connectors, etc., may be used.

The mounting pad 320 may, additionally or alternatively, include a centrally located slot 324. In some embodiments, the centrally located slot 324 may generally be located near the center of the mounting pad 320. In other embodiments, the centrally located slot 324 may be located in any suitable location on the mounting pad 320. The centrally located slot 324 may generally and substantially align with the base of the luminous panel 104. The luminous panel 104 may be inserted into the centrally located slot 324. In some embodiments, the centrally located slot 324 may be an opening, or hole, that allows the luminous panel 104 to pass partly and/or substantially through. In other embodiments, the centrally located slot 324 may narrow or close, such that the luminous panel 104 may not pass through, thereby preventing the luminous panel 104 from lowering further into the body of the candle. In various embodiments, the luminous panel 104 may connect to the centrally located slot 324, and/or other internal structure, using friction fit, a bayonet fit, snap fit, screws, adhesives, or any other suitable method. The luminous panel 104 may, additionally or alternatively, be directly or indirectly affixed by an adhesive, a screw, a friction fit, a bayonet fit, or any other suitable method to some other structural feature of mounting pad 320, to the mounting base 108, and/or to the body 102. It may be appreciated that any suitable method may be used to hold the luminous panel 104 in place, such that the display panel 200 may be generally viewable from the exterior of the candle body.

In some embodiments, the luminous panel 104 may not be fixed in place; that is, it may be adjustable. In such embodiments, there may be a lifting mechanism to raise and/or lower the luminous panel 104 into and out of the body 102 of candle 100.

The Lifting Mechanism

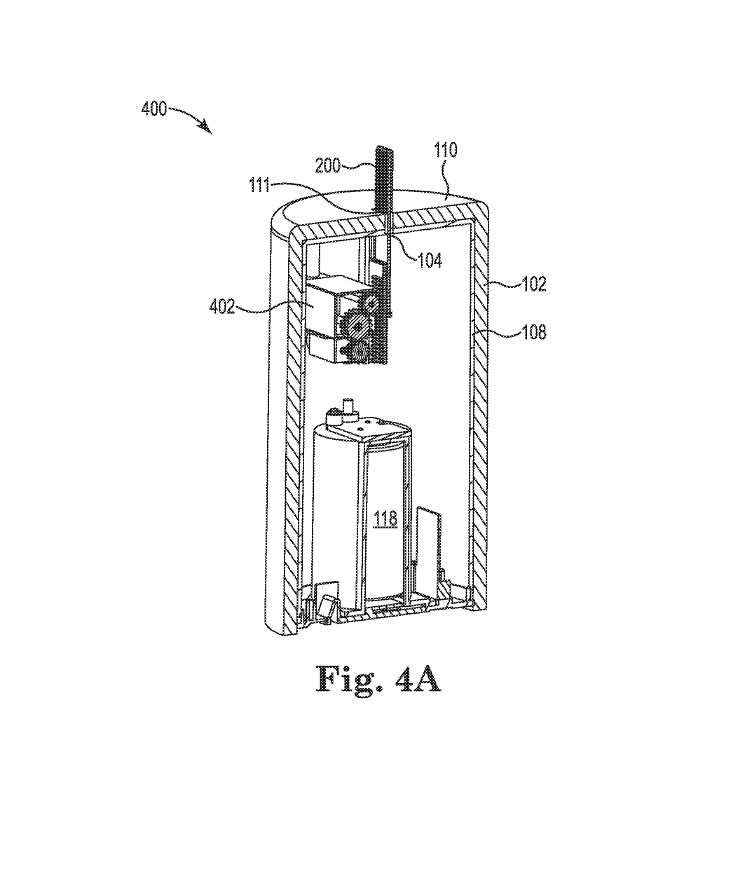

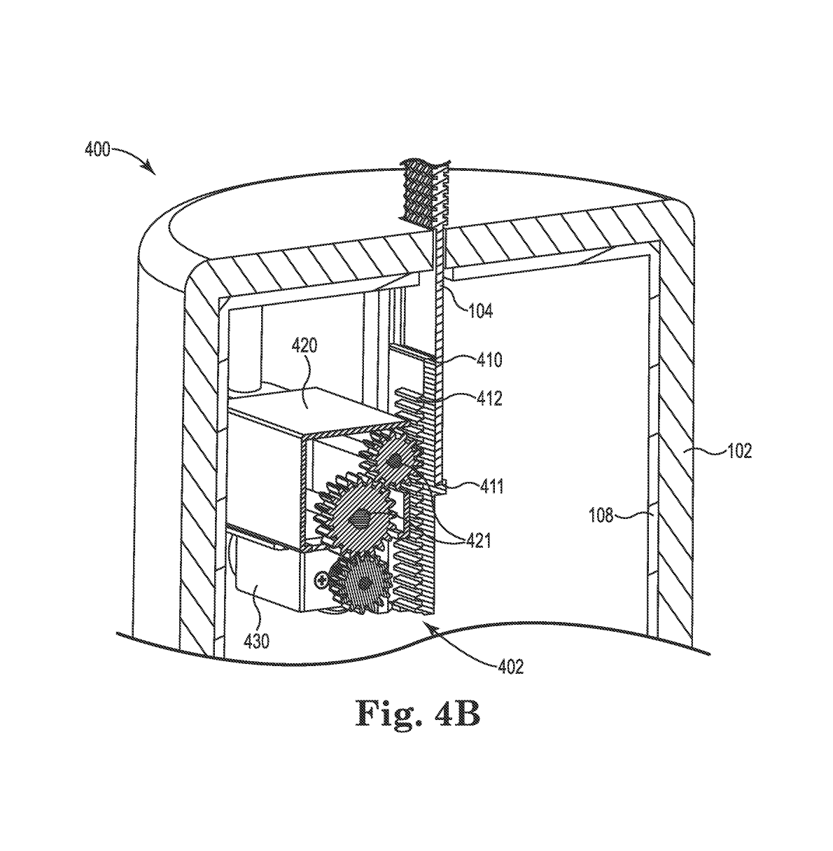

Referencing FIG. 4A, a lifting mechanism 402 may be used to expose the display panel 200 while activated, or ON, but to withdraw the display panel 200 mostly or substantially within the body 102 while not in use, or OFF. That is, the lifting mechanism 402 may lower the luminous panel 104 into the body 102 of candle 400, such that the display panel 200, or some portion thereof, may be substantially secured or encased inside the candle 400. Similarly, the lifting mechanism 402 may raise the luminous panel 104 out of the body 102 of candle 400, such that the display panel 200, or some portion thereof, may be substantially exposed outside the candle 400. The lifting mechanism 402 may be installed in the mounting base 108; however, any suitable location for the lifting mechanism 402 may be used. The lifting mechanism 402 may be mechanically connected to the luminous panel 104 via a direct or indirect connection, or any combination thereof.

In at least one embodiment, the lifting mechanism 402 may use a rack and pinion system to raise and/or lower the luminous panel 104. As seen in FIG. 4B, the lifting mechanism 402 may be comprised of one or more components for raising or lowering the luminous panel 104 including, but not limited to, a lifting plate 410, gear box 420, and driver 430.

The lifting plate 410 may be mechanically connected to the luminous panel 104, wherein raising the lifting plate 410 may raise the luminous panel 104, and conversely, lowering the lifting plate 410 may lower the luminous panel 104. The mounting base 108 may contain a slide, which may be configured to fit the lifting plate 410 into it. In some embodiments, an edge of the lifting plate 410 may sit and move vertically within the slide. In some embodiments, another side of the lifting plate 410 may contain a locating slot 411, which may support the luminous panel 104. That is, the bottom of the luminous panel 104 may connect with the locating slot 411 by any suitable method including, but not limiting to, sliding into it, resting on it, locking into it, any other suitable method, or any combination thereof. In some embodiments, another side of the lifting plate 410 may contain a lifting gear 412. In various embodiments, the lifting gear 412 may be comprised of one or more grooved slots and teeth, often referred to as a rack.

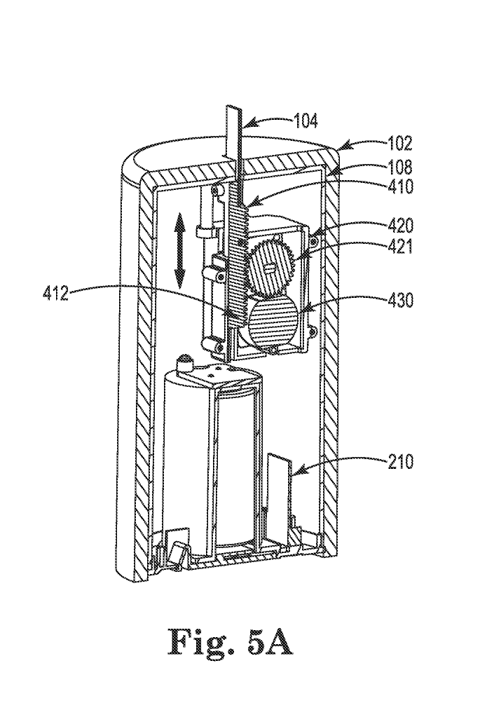

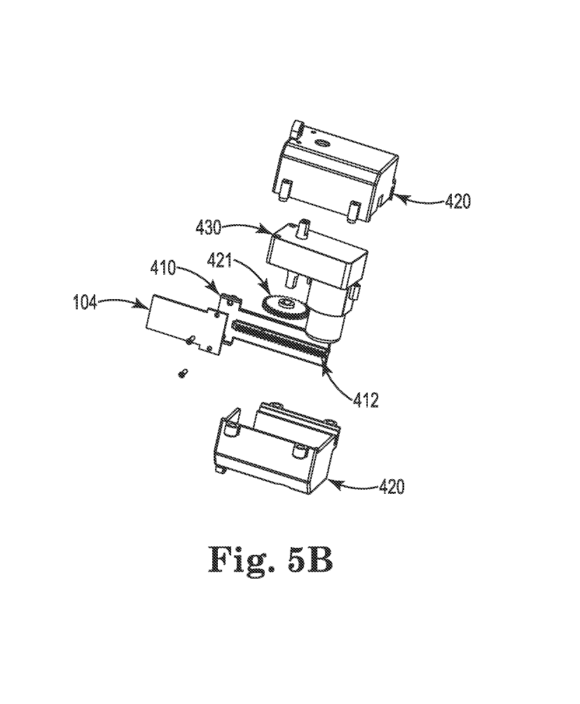

In some embodiments, a gear box 420 may facilitate the movement of the luminous panel 104 into and out of the candle body 102. The gear box 420 may contain one or more transmission gears 421. Each transmission gear 421 may be comprised of one or more grooved gear slots and corresponding gear teeth. Each of the one or more transmission gears 421 may be configured such that the grooved slots and gear teeth from one transmission gear 421 may link or connect with the grooved slots and gear teeth from another transmission gear 421, thereby performing a meshing transmission. In this way, by turning one transmission gear 421 each other transmission gear 421 may also turn. One of the one or more transmission gears 421 may link or connect to perform a meshing transmission with the grooved teeth of the lifting gear 412, such that turning the transmission gear 421 in one direction may cause the lifting gear 412 to lower and by turning the transmission gear 421 the other direction may cause the lifting gear 412 to rise. That is, turning a transmission gear 421 in a clockwise or counter-clockwise direction may raise or lower the lifting gear 412 in a linear direction. In another embodiment, as seen in FIGS. 5A and 5B, a gear box 420 may contain a single transmission gear 421.

In still other embodiment, the gear box may be eliminated and the lifting plate may interact directly with a driver 430. Referencing FIGS. 4B and 5A, the driver 430 may be configured to cause a transfer of motion to the lifting plate. In one embodiment, the driver 430 may be an electric motor, which may mechanically connect to the transmission gear 421. The activation of the driver 430 may facilitate the turning of one of the one or more transmission gears 421 such that the luminous panel 104 moves up or down. In another embodiment, the driver 430 may be an oil hydraulic pump. An oil hydraulic pump may be used to facilitate the turning of the one or more transmission gears, or alternatively, to directly raise or lower the luminous panel 104. However, any suitable method to lift or lower the luminous panel 104 may be used.

In various embodiments, the driver 430 may be electrically connected to the control panel. In this manner, activating or deactivating one or more control switches may cause the driver 430 to affect either the raising or lowering of the luminous panel 104 through the through hole 111, as desired. In other embodiments, the driver 430 could be on a timer, which controls when the luminous panel 104 is to be raised and lowered. In one embodiment, the raising or lowering of the luminous panel 104 may be configured to activate the display panel 200, such that the display panel 200 may be activated with or after rising of the display panel above the top surface 110 of the candle. In other embodiments, the display panel 200 may be configured to activate at any time and in any position.

In another embodiment, using for example a spring-loaded lifting mechanism, any portion, or all, of the luminous panel 104 may be pushed down into the body 102 of the candle 100, 400 by a user, such that at least a portion of the luminous panel 104 locks into place within the body and is no longer exposed. The user may then return the luminous panel 104 to a generally exposed position by, for example and example only, depressing the remaining exposed portion of the luminous panel thereby unlocking it, which may raise the luminous panel 104 out of the body 102. In some embodiments, the depressing of luminous panel 104 into the body 102 of the candle 100 may also be configured to act as a control switch, such as that disclosed in U.S. application Ser. No. 14/297,862, filed Jun. 6, 2014, entitled “Electric Flameless Candle,” herein incorporated by reference in its entirety. In some embodiments, one or more other control switches may additionally or alternatively be used.

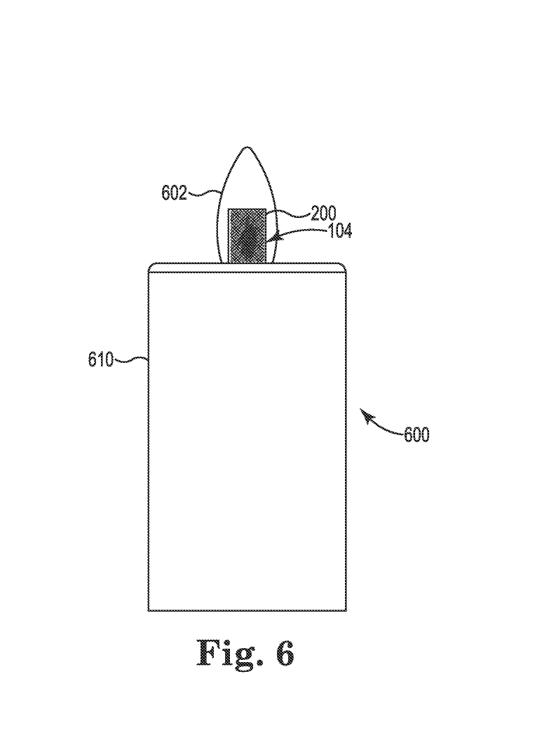

In some embodiments, the luminous panel 104 may additionally include a transparent, semi-transparent, translucent and/or semi-translucent coating layer. As seen in FIG. 6, a coating layer 602 (herein referred to interchangeably as casing 602) may generally cover the surface of the display panel 200 of the luminous panel 104. In various embodiments, the casing 602 may be shaped in appearance like a flame. In other embodiments, the casing 602 may be additionally or alternatively shaped to generally match the shape of the luminous panel 104. In still other embodiments, the casing 602 may be shaped in appearance like a traditional light bulb. That is, the casing 602 may be generally spherical, elongated, or any other suitable shape, or any combination thereof. In some embodiments, one or more casings 602 may be used. For example, a casing 602 may be molded onto the luminous panel 104, such that it substantially matches the shape of the display panel 200. A second casing 602 may be placed over the luminous panel 104 that is generally shaped in appearance like a traditional light bulb. As may be appreciated, zero, one, or more casings 602 may be used on the various embodiments herein.

In various embodiments, the casing 602 may protect the illuminators from being damaged. The casing 602 may be comprised of one or more materials, including but not limited to, glass, plastic or polymer, metal, any other suitable material, or any combination thereof. In various embodiments, the casing 602 may, additionally or alternatively, be comprised of one or more composites. In some embodiments, the casing 602 may be comprised of an epoxy resin composite. In some embodiments, the casing 602 may additionally or alternatively be comprised of silica composite. It may be appreciated that one or more other suitable composites may additionally or alternatively be used to create the casing 602.

In some embodiments, the casing 602 may give the lighting device a more vivid glowing effect when in use. In some embodiments, the coating layer 602 may, additionally or alternatively, modulate the light emitted by the illuminators. In at least one embodiment, the light may be modulated by the cover layer 602 such that light emitted by the illuminators may be less irritating to a user's eyes, especially after long term exposure. In some embodiments, the casing 602 may be configured so as to sort of blend the light from the illuminators, such that individual illuminators are tough to discern, so as to give a unitary flame-like illumination.

The one or more casings 602, may be substantially permanent. For example, in some embodiments, the casing 602 may be molded onto the display panel 200. In other embodiments, the casing 602 may be glued on to the display panel 200. However, in other embodiments, the casing 602 may be easily detachable from the display panel 200 or luminous panel 104. In various embodiments, the casing 602 may slide on, top-down, sideways, or some combination thereof, onto the display panel 200 or luminous panel 104. In at least one embodiment, the casing 602 may snap into place on the display panel 200 or luminous panel 104. In another embodiment, the casing 602 may connect to the display panel 200 or luminous panel 104 via a friction fit. In other embodiments, a lock-and-groove may be used to temporarily secure the casing 602 onto the display panel 200. Any other suitable means to connect the casing 602, either directly or indirectly, permanently or removably, onto or over the display panel 200 or luminous panel 104 may be used. In at least one embodiment, the casing 602 and luminous panel 104 may, collectively, be lowered into the body of the candle 600 by one of the lifting mechanism methods discussed above.

The Control Panel

The control panel 210 (also referred to interchangeably herein as control circuit) may independently control one or more of the illuminators to form a glowing flame effect on the one or more display panels 200. The control panel 210 may be in electrical communication with one or more of the illuminators 202, 204. In various embodiments, the control panel 210 may be configured to independently turn ON/OFF one or more of the illuminators. In addition, the control panel 210 may be configured to independently control the electrical current provided to each of the one or more illuminators and thereby control the brightness and/or dimness of the illuminators individually.

In various embodiments, in addition or alternatively to the control panel 210, one or more other control circuits or control panels may control one or more of the illuminators 202, 204 in order to form a dynamic flame effect on the display panel 200. In one embodiment, the control panel may be configured to independently trigger one or more illuminators 202, 204 (of other light sources, as discussed below) to perform one or more functions including, but not limited to, turning ON, turning OFF, brightening or fading in, dimming or fading out, any other function, or any combination thereof. The control panel 210 may be electrically connected to the power source 118. In some embodiments, the control panel 210 may be connected to the power source 118 using a flexible circuit board. In some embodiments, the control panel 210 may, additionally or alternatively, be connected to the power source 118 using electrical wiring. In some embodiments, the control panel 210 may, additionally or alternatively, be connected to the power source 118 using wire harness clips. Any suitable method to connect the one or more control panels 210 to a power source 118 may be used. In some embodiments, as seen in FIG. 2, the control panel may be mechanically connected to the luminous panel 104. In some embodiments, a control panel 210 may be additionally or alternatively located elsewhere, for example, near the power source 118 (as seen, for example, in at least FIG. 5A). It may be appreciated that any suitable location for any control circuit and/or control panel 210 may be used.

Power

As discussed above, a control switch may be located on the bottom surface 114 of the candle 100, 400. The one or more control switches may be configured to perform one or more functions including, but not limited to, raising up the luminous panel, lowering the luminous panel, activating or deactivating an illuminator on the display panel, causing an illuminator to flicker, dimming or brightening an illuminator, any other function, and any combination thereof.

Referencing back to FIGS. 1 and 4, a power source 118 may be located within the body 102 and/or mounting base 108. In various embodiments, the power source may be accessed via a cover 116. In other embodiments, the power source may be located in any location, including but not limited to, externally. The power source may include, but is not limited to, a dry battery, a disposable battery, a rechargeable battery, a power cord and attachment, any other known or suitable power source, or any combination thereof. In at least one embodiment, 1.5V batteries may be used. In various embodiments, based on demand, one to four 1.5V batteries may be used. In other embodiments, more than four 1.5V batteries may be used. It should be appreciated that any type or size of battery, as well as any number of batteries, may be used to provide power.

The Flameless Light Bulb

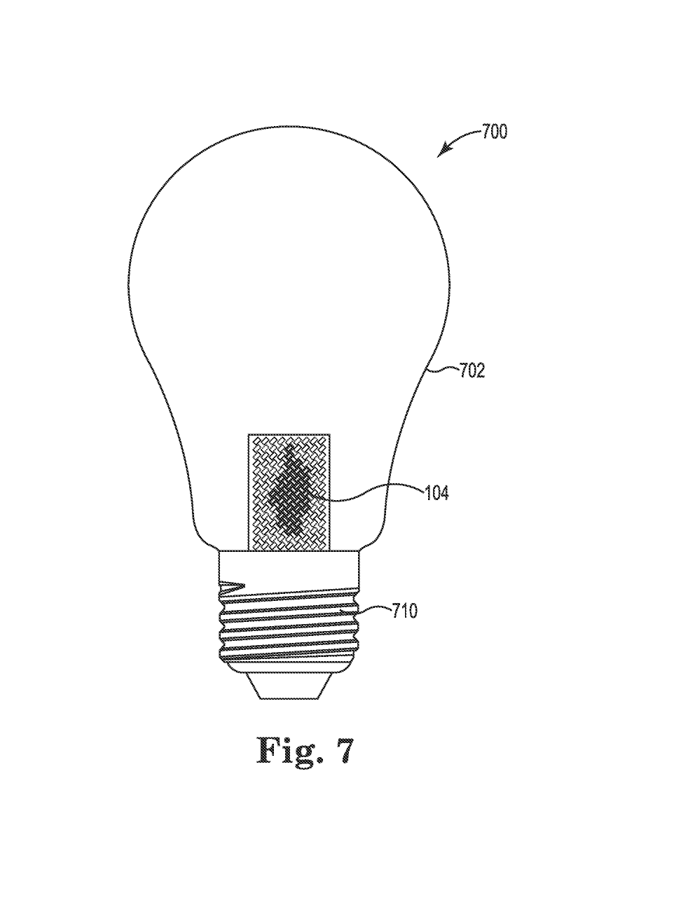

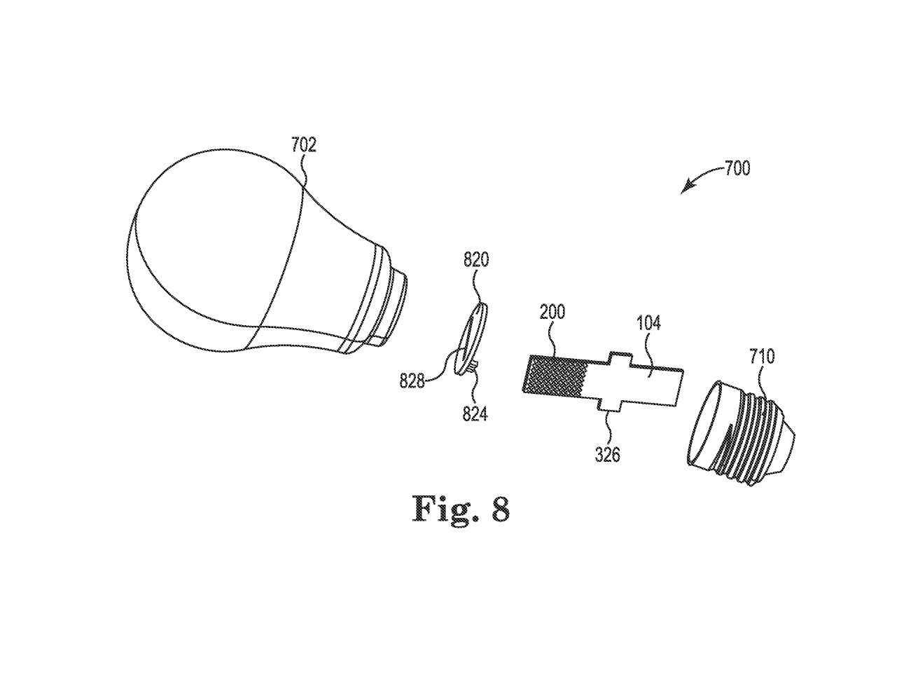

In another embodiment, referencing FIGS. 7-8, a casing 702 resembling a standard light bulb may encase a luminous panel 104, or some portion thereof. In various embodiments, a flameless light bulb may have a mounting base 710 to which the casing 702 and/or luminous panel 104 may mechanically connect. In various embodiments, the mounting base 710 may have external threads. The external threads may be used to screw into a traditional light socket, such as but not limited to an E11, E12, E14, E17, E26, E27, E39, E40, MR16, or any other suitable light bulb socket, thereby providing power to the luminous panel 104. In various embodiments, the illuminators on the display panel may automatically activate once power is supplied to the luminous panel, control circuit, and/or control panel. In some embodiments, one or more functions may be activated based on the varying power provided. For example and example only, on a lamp that provides for more than one dimming or brightness capability the luminous panel may change its functionality from dynamic flame, to static flame, to pulse, and then to OFF as the different stages are activated.

As seen in exploded FIG. 8, a mounting pad 820 (herein referred to interchangeably as a disc retainer 820) may, generally, have a circumference similar to in size and shape to the circumference of the mounting base 710. In various embodiments, the circumferential size and shape of the mounting pad 820 may be slightly smaller than the circumferential size and shape of the mounting base 710, such that the mounting pad 820 may fit within the mounting pad 710. In other embodiments, the circumferential size and shape of the mounting pad 820 may be the same or slightly larger than the circumferential size and shape of the mounting pad 820. In various embodiments, the mounting pad 820 may include one or more limit slots 824, which may be used to connect or mesh with the mounting base 710. In various embodiments, the limit slot 824 may connect with one or more structures in the mounting base 710 using a friction fit, snap fit, bayonet fit, screw, or any other suitable means.

The limit slots 824 may, additionally or alternatively, be used to connect the luminous panel 104 to the mounting pad 820. The limit slots 824 may be generally sized and shaped to cooperate with the protruding arms, or stoppers 326, of the luminous panel 104, such that the luminous panel 104 may generally be held into an optimal position. That is, the limit slots 824 and stoppers 326 may cooperate to prevent the luminous panel 104 from moving either up through the disc retainer 820, down through the disc retainer 820, or both, as is desired or necessary. The casing 702 may connect to the disc retainer 820. In one embodiment, the casing 702 may connect, and in some cases substantially permanently connect, to the mounting base 710 by a bolt, screw, or other suitable securing mechanism. In another embodiment, the casing 702 may have external threads that screw into internal threads within the mounting base 710, thereby securing attachment. It may be understood that any suitable method of attaching the casing 702 to the mounting base 710 may be used.

The mounting pad 820 may additionally include a through-hole 828, as discussed above. The through-hole 828 may generally and substantially align with the luminous panel 104. In various embodiments, a portion of the luminous panel 104 may pass through the through-hole 828. In other embodiments, the through-hole 828 may be comprised of a slot which prevents direct connection of the luminous panel 104 to any other structure. The power supplied to the luminous panel 104 may be provided from the mounting base 710, which may be in electrical connection to one or more other power sources. The luminous panel 104 may be electrically connected to the mounting base 710.

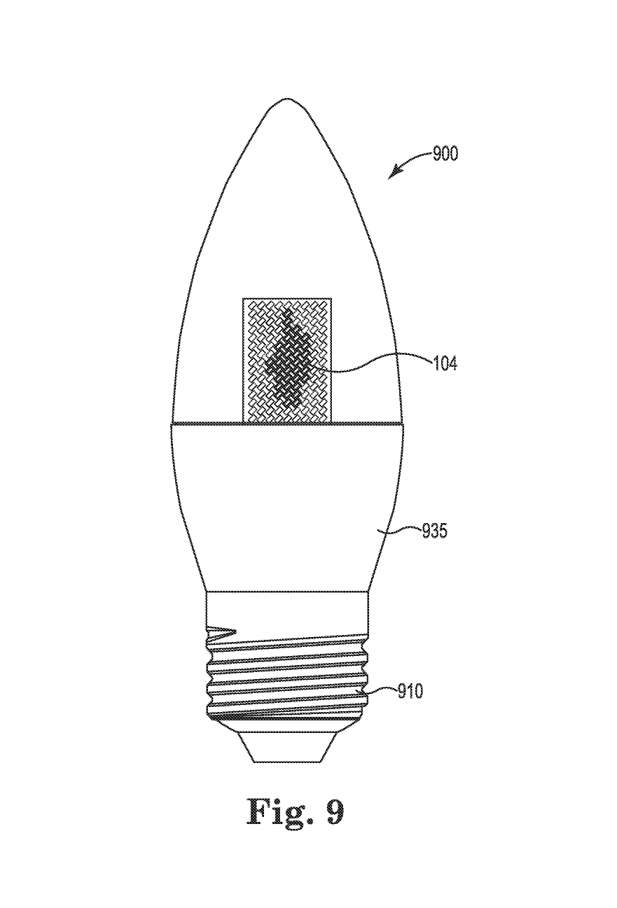

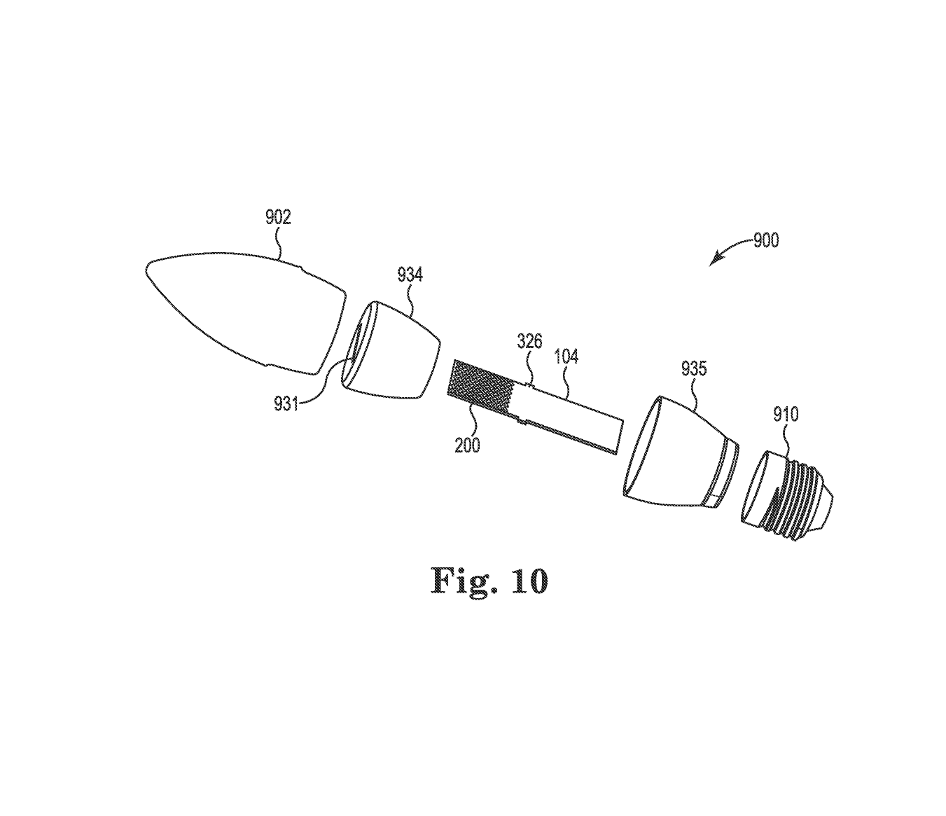

Referencing FIG. 9 and exploded FIG. 10, a casing 902 resembling a light bulb may encase the luminous panel 104, or some portion thereof, but may also include an accommodating base 935. The accommodating base 935 may, in various embodiments, be generally opaque, generally transparent, or any degree of transparency between opaque and transparent. The accommodating base 935 may, additionally or alternatively, be translucent, thus giving off light. In various embodiments, the casing 902 may attach to the accommodating base 935. The accommodating base 935 may have an accommodating chamber, which may house some portion of the luminous panel 104. The accommodating base 935 may be further comprised of a fastening piece 934. In some embodiments, the size and shape of the fastening piece 934 may generally be similar in size and shape to the accommodating base 935, such that the fastening piece 934 may generally fit within the accommodating base 935. The fastening piece 934 may have a slot or through hole 931 that may, generally, match the cross section of luminous panel 104, such that luminous panel 104 may slide through slot 931. The slot 931 may be configured such that it has a width greater than the average cross section of luminous panel 104 but smaller than the width of luminous panel 104 at the cross section that includes stoppers 326. Fastening piece 934 may mechanically connect, in any suitable method, with accommodating base 935 thereby securing the luminous panel between fastening piece 934 and accommodating base 935. Accommodating base 935 may connect with the mounting base 910. In one embodiment, accommodating base 935 may have external threads that match generally with internal threads in mounting base 910 such that they may screw together. In another embodiment, the accommodating base 935 may be secured to, and in some cases secured substantially permanently to, mounting base 910 with a bolt, screw, and/or other securing mechanism(s). As discussed above, the mounting base 910 may be screwed into a light socket for existing domestic light bulbs, such as but not limited to E11, E12, E14, E17, E26, E27, E39, E40, MR16, or any other suitable light socket.

The control panel, or control circuit, may be located on the luminous panel 104, within the mounting base 710, 910 or any other suitable location. As discussed above, the mounting base 710, 910 may be in electrical communication with one or more power sources. The control panel, and luminous panel, may be in electrical communication with the mounting base 710, 910. In various embodiments, the control panel and/or luminous panel may be electrically connected to the mounting base 710, 910 (and/or to each other) using a flexible circuit board, electrical wires, wire harness clips, and/or any other suitable method. The flameless light bulbs 700, 900 may or may not have one or more external control switches that may activate or deactivate one or more functions of luminous panel 104.

As may be appreciated, embodiments of the invention may be used in a variety of lighting devices contemplated by the present disclosure and include, but are not limited to, lanterns, wishing lamps, torches, fireplaces, outdoor lamps, wall lamps, flashlights, desk lamps, floor lamps, etc.

Functionality

Referencing back to FIG. 2, a luminous panel 104 may have a display panel 200 and a control panel 210. The control panel 210 may control the illuminators 202, 204 on the display panel 200. As discussed above, the control panel 210 may be located on the illuminator panel 104, at some other electrically connected location, and/or any combination thereof.

The illuminators 202, 204 may, in some embodiments, be arranged in one or more rows and/or columns. The control panel 210 may control independently the illuminators by turning them ON, turning them OFF, dimming and fading out, brightening and fading in, or any combination thereof. In various embodiments, the control panel 210 may use one or more signals comprised of random frequencies and amplitudes of current to independently control the illuminators. The circuit panel 210 may also control pulse-width modulation and the frequency and duty ratio of the signal(s) received by the illuminators. In at least one embodiment, a matrix method may be used to transmit a signal to the one or more illuminators. In one embodiment, the signal(s) may be an analog signal. In at least one embodiment, the signal(s) may be a digital signal. In some embodiments, the signal(s) may be random or randomized. The signal(s) transmitted to one or more of the LED lights on the luminous panel may cause the LEDs to produce what appears visually to be a natural flame which has a natural “flicker” of light to the human eye.

For example, as shown in FIG. 2, a plurality of illuminators may be turned ON, denoted by the dark shading, including illuminator 204. Several other illuminators, including illuminator 202 may be turned OFF, and thus are not shaded. In at least one embodiment, the pattern of the illuminators turned ON and turned OFF may form a pattern simulating the effect of a real flame. In another embodiment, other images or light configurations may be formed. Any one or more illuminators may be turned ON, turned OFF, change between one or more colors, brightened, dimmed, or may generally flicker in order to simulate a true flame's natural movement, brightness, colors, and flicker.

However, it may be understood that any suitable method to illuminate the display panel, or some portion thereof, may be used. For example, only one illuminator may illuminate. In another example, all illuminators on the display panel may illuminate. In still another example, only one row and/or one column may illuminate. Other configurations of illuminated lights, static shapes, and/or dynamic shapes are considered and within the scope of the present disclosure.

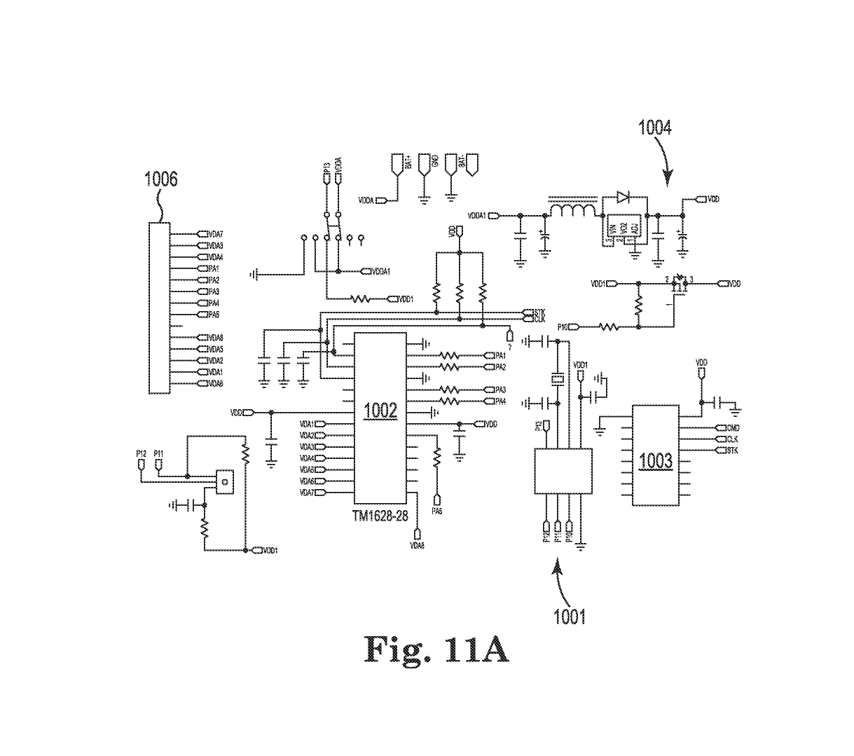

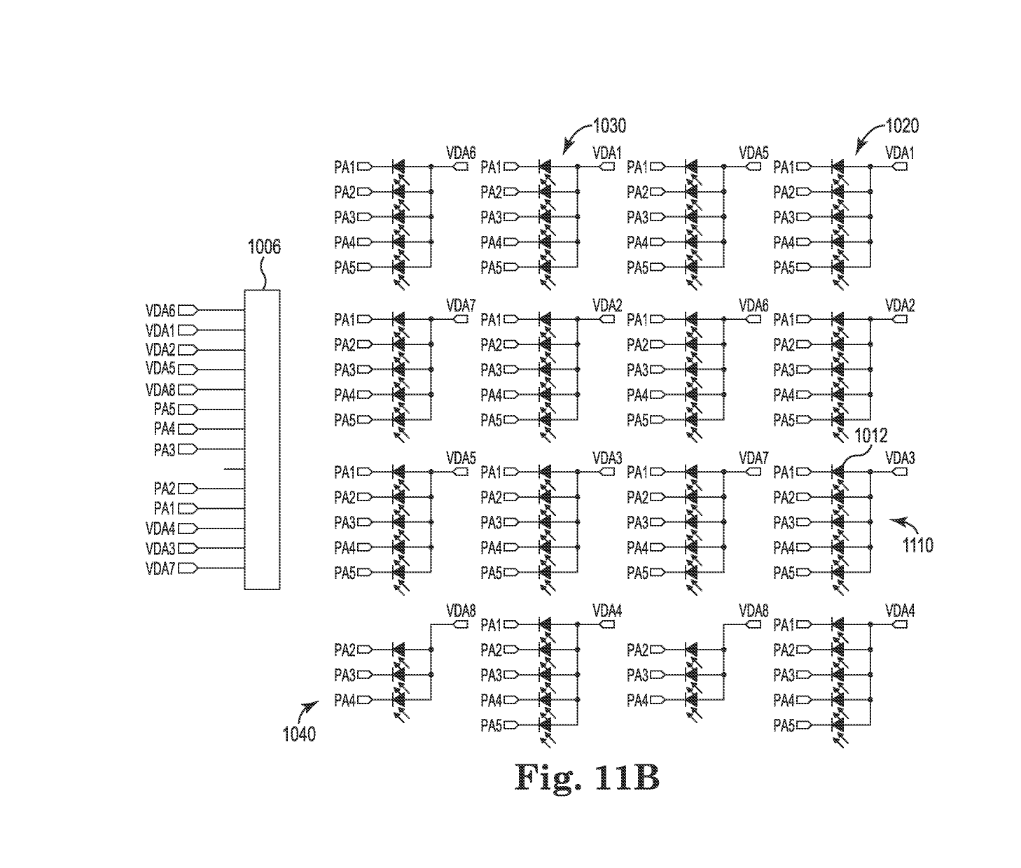

With reference to FIG. 11A, in one embodiment, the control panel 210 may be comprised of an LED driver circuit 1001. The LED driver circuit 1001 may be comprised of one or more microcontrollers (MCUs) 1002, 1003 and one or more other electrical components. The one or more MCUs and one or more other electrical components may be capable of generating the one or more signals used to illuminate the LEDs. In some embodiments, the MCUs and other LED driver components may perform communication using serial communication in order to generate signals for the plurality of LEDs. In various embodiments, the MCUs and other LED driver components may perform communication, additionally or alternatively, using parallel communication in order to generate signals for the plurality of LEDs. In various embodiments, a given signal or combination of signals may cooperate to turn ON, turn OFF, change the color of, brighten, dim, adjust the grayscale of the display area, and/or generally cause an LED to flicker to achieve the effect of dynamic variation of the flame.

In at least one embodiment, an MCU may be a specific LED driver integrated circuit (IC), such as but not limited to, Shenzhen Titan Micro Electronics Co., LTD's LED Driver model TM1628. One TM1628 data sheet, incorporated herein in its entirety, may be found at http://www.datasheet-pdf.com/datasheet-html/T/M/1/TM1628_TitanMicroElectronics.pdf.html. In other embodiments, one or more other MCUs or specific LED driver ICs may, additionally or alternatively, be used. LED driver IC 1002 and/or one or more other MCUs 1003 may, generally, cooperate to generate the one or more signals, which may be sent to each of the one or more LEDs. As seen, one or more signals, represented by VDA1-VDA8 and PA1-PA5, may be sent to the LEDs using the connector 1006. The connector 1006 may be comprised of the electrical wire, flexible circuit board, wire harness clips, and/or any other suitable connecting method.

In one embodiment, a power supply assembly may be used to provide power to the LED driver circuit 1001. Referencing the schematic in FIG. 11A, the power supply assembly may include one or more voltage regulator ICs 1004 (herein also referred to interchangeably as booster IC) as well as other electrical components. The voltage regulator IC 1004 may be capable of adjusting the supplied voltage received from the power supply 118. For example, in one embodiment, a booster IC 1004 may raise the voltage from the one or more 1.5V batteries to 5 volts before supplying the voltage to the LED driver circuit 1001.

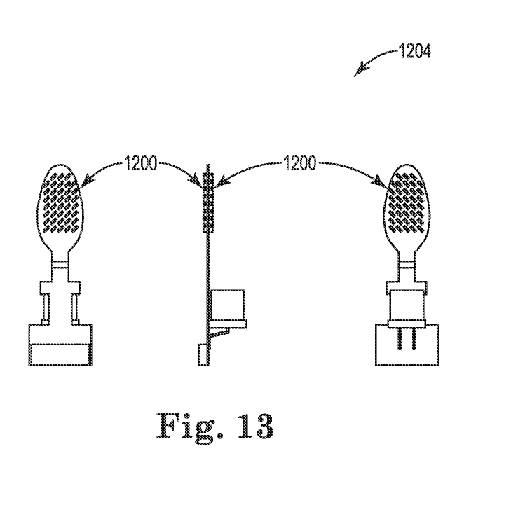

As discussed herein, a matrix of LEDs may be used. The schematic of FIG. 11B may represent at least one embodiment of the matrix, shown for example in FIG. 13. The one or more signals generated by the LED driver circuit 1001 may be received by the one or more LEDs, for example, via connector 1006. As discussed, the LEDs may be wired in one or more series, one or more groups of parallel connected LEDs, or in some combination thereof, as shown by at least LED groups 1010, 1020, 1030, and 1040. In some embodiments, as seen in FIG. 11B, each LED group 1010, 1020, 1030, and 1040 may represent one or more LEDs in a row of the matrix. In other embodiments, each LED group may represent one or more LEDs in a column of the matrix. As may be appreciated, each LED group may represent one or more LEDs in any possible configuration, including but not limited to, a cluster, a diagonal line, a random grouping, and/or any other suitable configuration. As seen, each LED group may, collectively or individually, be driven by a signal, VA1-VA8. Each LED in the respective LED group may additionally be driven by an independent signal, PA1-PA5. For example, each LED in LED group 1010 may be collectively driven by signal VDA3, while each individual LED in LED group 1010 may additionally be driven by an independent signal, PA1-PA5. For a more specific example, signals VDA3 and PA1 may cooperate to turn ON, turn OFF, brighten, dim, and/or cause LED 1012 to flicker, as desired.

As mentioned, one or more LED groups may be used to create the matrix or other configuration of the display panel. As described above, and seen more clearly in reference to FIG. 13, two or more display panels may be placed on the luminous panel. In the embodiment of FIG. 11B and with continued reference to the matrix seen in FIG. 13, the LED group 1010 may represent the LEDs in the third row in the matrix and include the five LEDs in each of the five columns. Likewise, LED group 1040 may represent the LEDs in the eighth or top row in the matrix of FIG. 13 and include the three LEDs in each of the central three columns.

Furthermore, a luminous panel with a display panel on two or more sides may be configured such that the same image may be displayed on each display panel. As such, in one embodiment, each display panel or side of the luminous panel may include a corresponding LED group that is driven identically. For example, as seen in FIG. 11B, the LEDs in LED series 1020 and 1030 are both wired to be driven collectively by signal VDA1 and, additionally or alternatively, individually by signals PA1-PA5, respectively. In some embodiments, LED groups 1020 and 1030 may be driven by one or the cooperation of two or more signals such that each LED group illuminates to form the same or mirrored shape or pattern on each display panel. However, in other embodiments, LED groups 1020 and 1030 may be driven completely independently of each other.

Referencing FIG. 11C, a further example of some control panel components are illustrated in a schematic. As discussed above, the one or more illuminators or LEDs 1108 may be connected in different LED groups 1110, 1120, 1130, 1140, 1150, 1160, 1170, 1180. In some embodiments, as shown, each group may connect to a plurality of different illuminators or LEDs.

In some embodiments, as seen in FIG. 11C, the LED driver circuit may be comprised of multiple MCUs, 1190, 1192, and 1194 and one or more other electrical components, shown at least by 1196. As should be appreciated, any number of MCUs and/or any other electrical components may be used in various embodiments to achieve the results desired. The one or more MCUs and other electrical components may produce one or more signals, which may be used to drive the LED lights. The one or more signals may cooperate to drive one or more LEDs, as desired. For example, each LED in group 1110 may be, individually or collectively, driven by signal or input 1102. Another signal represented by signal or input 1104, may provide another signal, that individually or in cooperation with signal 1102 may cause one or more LEDs to turn ON, turn OFF, brighten, dim, or otherwise flicker, as desired. In various embodiments, input 1104 may cause results including, but not limited to, generally or temporarily limiting the power provided to the series of illuminators, causing substantially no power to get to the illuminators, causing substantially maximum power to get to the illuminators, or causing any amount of power between substantially none to substantially maximum to get to the series of illuminators. As may be appreciated from the schematic, therefore, inputs 1102 and 1104 may control the power to an entire series of illuminators.

In some embodiments, yet another input or signal for each LED of an LED group may additionally control each individual LED. For example, signal or input 1106 may additionally work to independently affect or drive LED 1108.

For example and example only, in various embodiments, the signal or input 1106 may control only the power provided to a single illuminator in an LED group. In another embodiment, signal or input 1106 may control the power to illuminators in different LED groups, such as multiple LEDs in different rows or columns. The signal or inputs 1102, 1104, 1106 may provide or limit power based on the one or more signals generated using the one or more MCUs 1190, 1192, 1194, one or more other electrical components 1196, one or more algorithms, and/or any other suitable method. The one or more signals may work, independently or in cooperation, to positively or negatively control the power supplied to each of the individual illuminators or LEDs. In at least one embodiment, using a scanning method, the MCUs may then send synchronized signals to notify other MCUs of varying power supply. In general, one or more signals may be transmitted to one or more illuminators, so as to create the effect of a flame, or any other image, that may change in shape, size, color, movement, etc.

### Further Embodiments

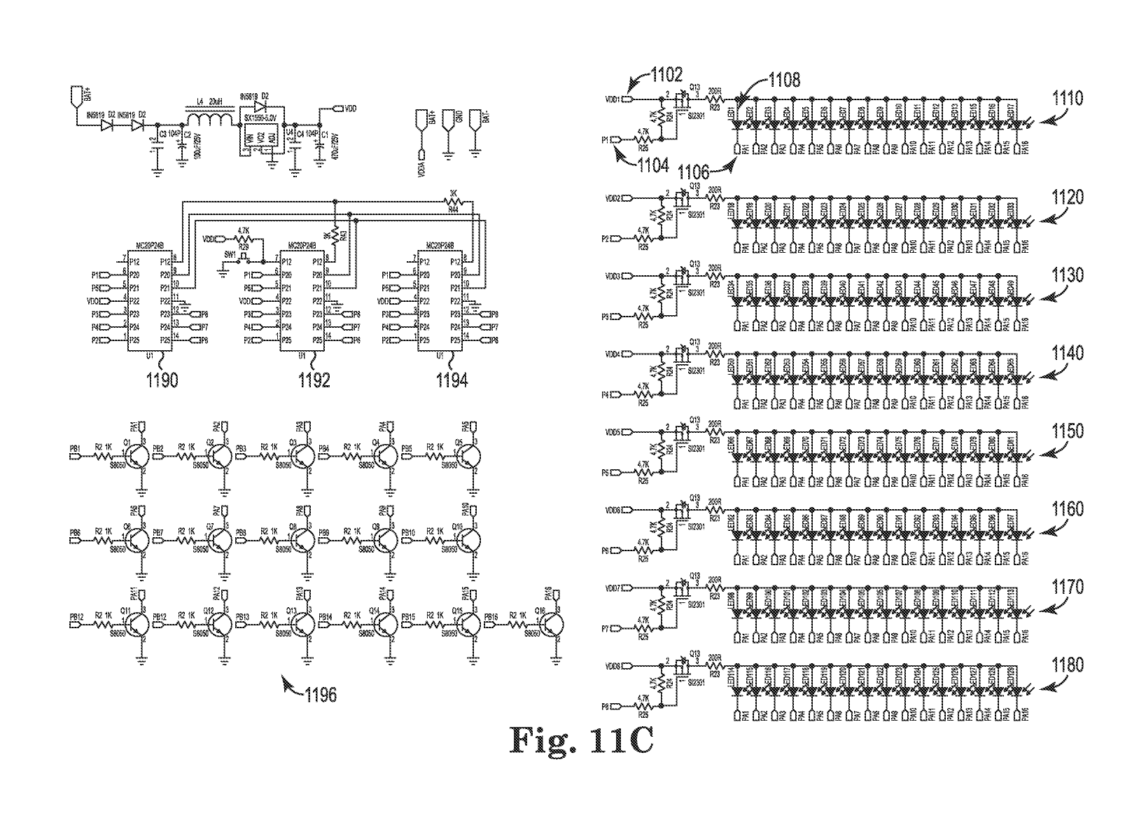

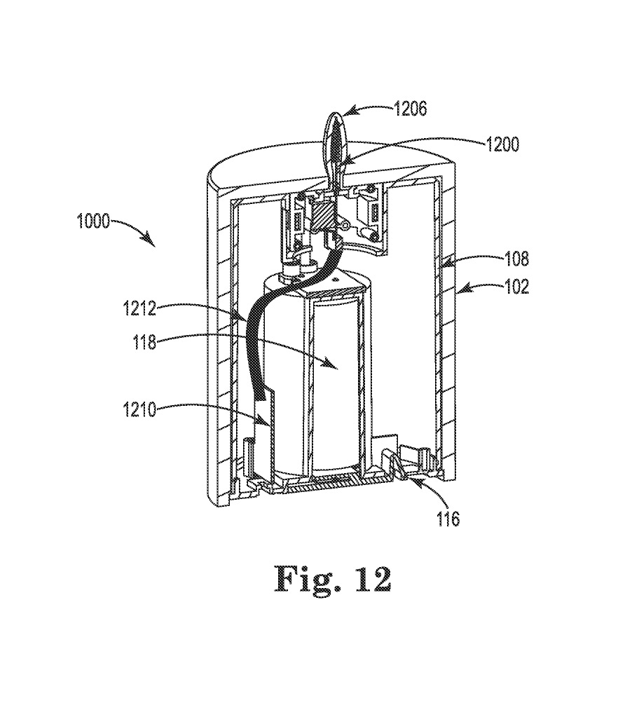

Referencing FIG. 12, an electronic candle 1000 of the present disclosure is shown. Several aspects of the electronic candle 1000 may be similar or in accordance with the discussion herein. For example, the display panel 1200 may or may not include a coating layer 1206, described above, to protect the display panel 1200 and the illuminators. Also, a control panel may be located anterior to the display panel 1200 on the luminous panel 104 and/or in some other location, such as near the power source, as seen in FIG. 12. In various embodiments, a means for electrical connection 1212, such as a wire or flexible circuit board, may connect the control panel 1210 to the display panel 1200.

As discussed above, the display panel 1200, and consequently the luminous panel, may come in a variety of shapes. Referencing FIG. 13, the luminous panel 1204 may include a display panel 1200 having an arc or rounded shape that may appear more flame-like than a rectangular luminous panel. As seen, the luminous panel 1204 may contain two display panels 1200, one on each side of luminous panel 1204. As discussed above, each matrix on the display panel 1200 may consist of one or more rows and one or more columns. In some embodiments, the matrix may be comprised of eight rows. In other embodiments, the matrix may be comprised of less than or more than eight rows. In some embodiments, the matrix may be comprised of five columns. In other embodiments, the matrix may be comprised of less than or more than five columns. In various embodiments, the number of LEDs in each column may vary. In other embodiments, the number of LEDs in each column may be the same. Similarly, in various embodiments, the number of LEDs in each row may vary. In other embodiments, the number of LEDs in each row may be the same. In at least one embodiment, as seen in FIG. 13, the matrix may be comprised of five columns, where the first column has seven LEDs, the second, third, and fourth columns have eight LEDs, and the fifth column has seven LEDs.

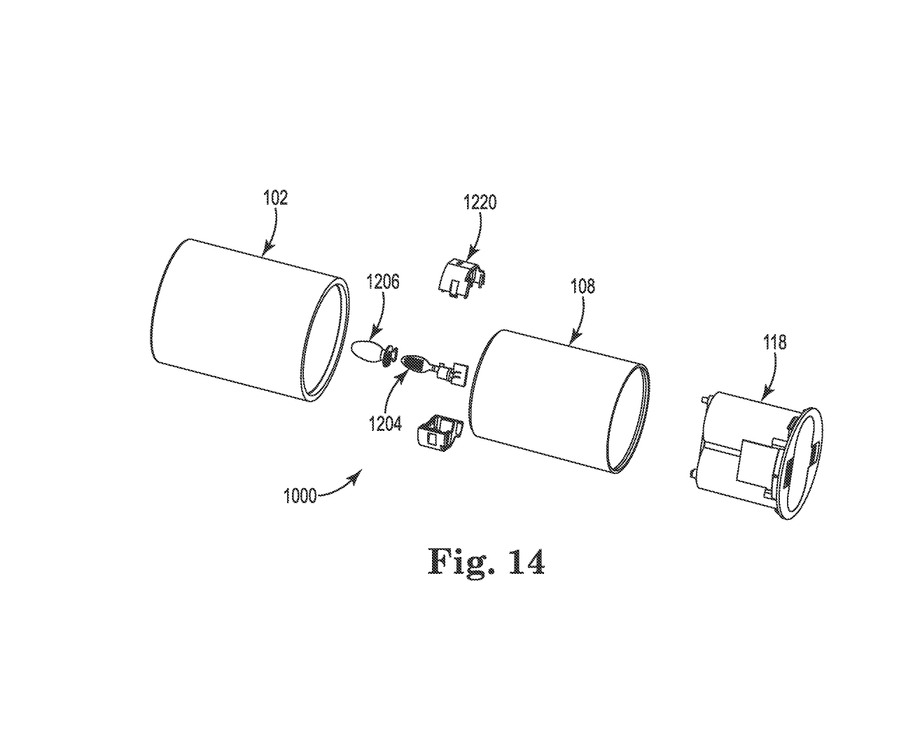

FIG. 14 shows an exploded perspective of an electronic candle 1000. A mounting pad 1220 may generally connect the mounting base 108, such that it may not fall below the top surface of the mounting base 108. As seen, the mounting pad 1220 may be comprised of one or more parts that may be connected by various methods, including but not limited to, snap fit, fastening, bayonet fit, friction fit, glued, threaded together, any other suitable method, or some combination thereof. The connected mounting pad 1220 components may include the luminous panel 1204 and/or coating layer 1206. The coating layer 1206 may similarly snap fit, fasten to, friction fit, bayonet fit, be glued to, be molded to, be molded onto, thread onto, or otherwise be connected to the luminous panel.

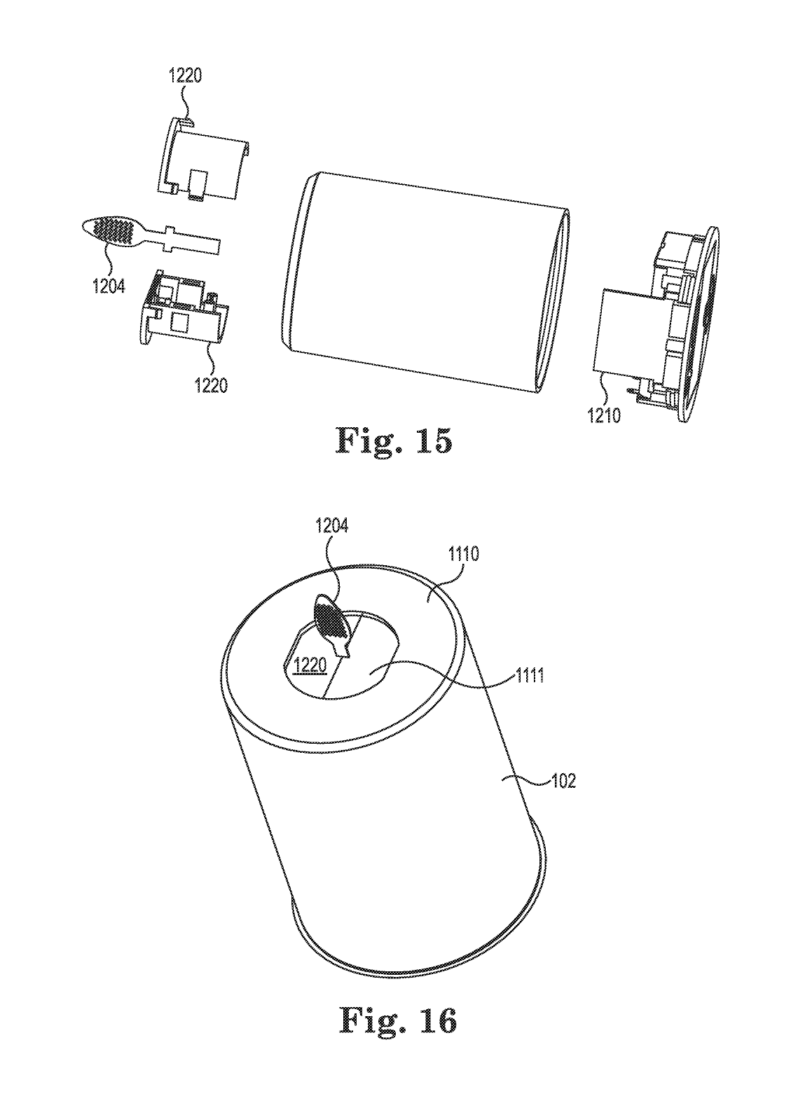

In various embodiments, referencing FIGS. 15 and 16, the through-hole 1111 (or through-hole 111 as seen in FIG. 1), on the top surface 1110 of the electronic candle may be any size. In various embodiments, where the through-hole 1111 is larger than necessary to secure the luminous panel 1204, the luminous panel 1204 may otherwise be secured using some other means. For example, the luminous panel may be secured into place by the mounting pad 1220.

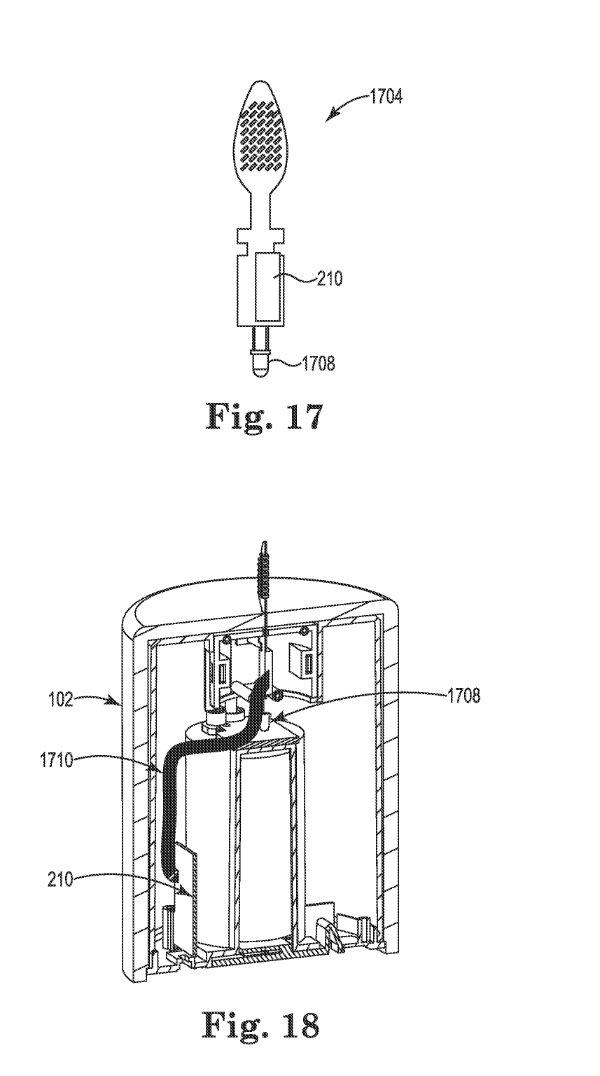

In various embodiments described herein, one or more additional light sources may be provided within the body of the candle. In some embodiments, as seen in FIGS. 17 and 18, the luminous panel 1704 itself may additionally include the one or more internal light sources 1708. The internal light source 1708 may be comprised of one or more LEDs. The internal light source 1708 may be electrically connected to the control panel and/or the luminous panel using one or more methods, including but not limited to, an electrical wire, a flexible circuit board, a wire harness clip, or any other suitable method. The internal light source 1708 may similarly be connected to one of the one or more control panels 210 using a flexible circuit board 1710. As is appreciated, an internal light source 1708 may, additionally or alternatively, be located at any location within the body 102 of the candle using any number of suitable connecting methods. The internal light source 1708 may transmit a light through the translucent material of the candle body 102 to generate a soft light. The internal light source 1708 may be generally ON, OFF, flicker, dim, brighten, or otherwise to simulate the effect of a burning flame. In combination with the dynamic burning effect simulating a real flame generated by the display panel, the internal light source 1708 may better simulate the effect of a true-flame candle.

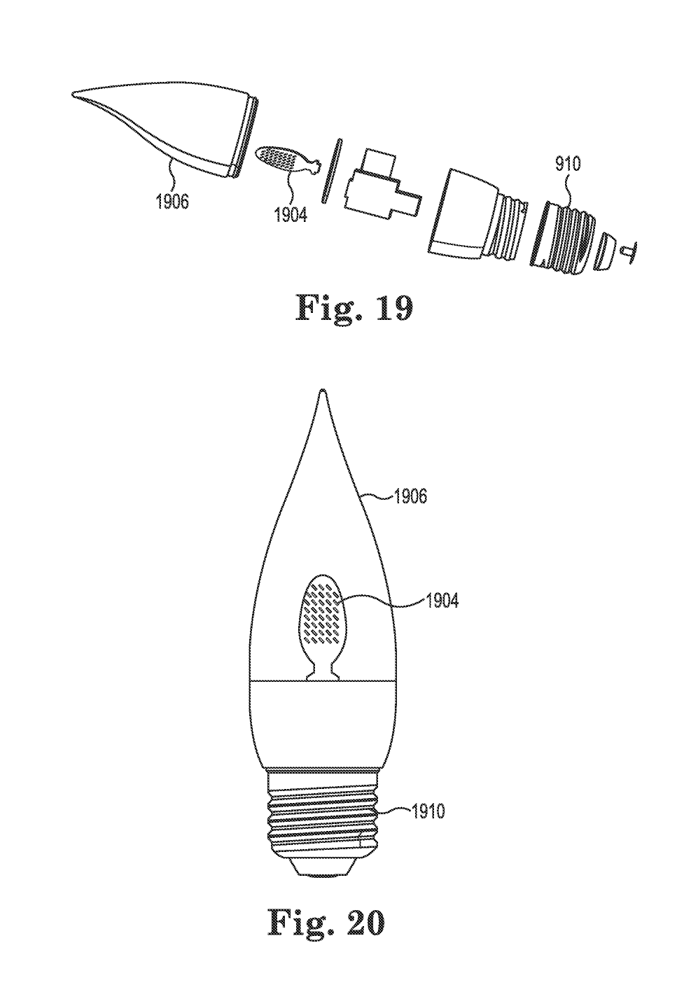

FIGS. 19 and 20 show a flameless light bulb of the present disclosure, as discussed above, that includes a display panel 1904 having a more flame-like appearance. A casing 1906 may additionally or alternatively be generally more tapered so as to better mimic a flame-like shape. The casing 1906 and display panel 1904 may be similarly connected to the threading 910 as discussed above.

In various embodiments, the lighting devices described herein may further include a sensor. In some embodiments, the sensor may sense the presence of wind or airflow. The sensor may convert the presence of wind or airflow into an electric signal, which may be used to drive the LEDs to flicker or dim in a way that mimics a true-flame. In some embodiments, the sensor may sense the direction of the wind or airflow. In such embodiments, the control panel may cause the LEDs or illuminators on the display panel(s) to generate a flame that leans to one side, simulating it is moving away from the wind or airflow. Likewise, the flame may also shrink in size in the presence of wind or airflow. Conversely, in the absence of wind or airflow, the LED display panel may generally light-up without, or with minimal, flickering as well as be generally centrally aligned on the display panel to simulate a true-flame burning in the absence of wind or airflow. It should be understood that other sensors that sense movement, sound, lighting conditions, or other environmental factors may be used, such as those discussed in U.S. patent application Ser. No. 14/297,862, filed on Jun. 6, 2014 entitled “Electronic Flameless Candle,” which is herein incorporated by reference in its entirety.

In various embodiments, the lighting devices described herein may further include a remote control. In at least one embodiment, an infrared remote control may be used. In some embodiments, the remote control may be used to control the ON/OFF status of the LEDs. In some embodiments, the remote control may additionally or alternatively be used to control the timing of the lighting device. For example, set the device to turn ON for 4 hours, 6 hours, 8 hours, and the like, after which the device will turn OFF, unless otherwise prompted. In some embodiments, the remote control may additionally or alternatively be used for other functions including, but not limited to, adjusting the brightness of the flame produced by the LEDs, adjusting the height of the flame, adjusting the colors of the flame, adjusting the degree and/or amount of flicker in the flame, or any other suitable function. It may be understood that one or more other control mechanisms may be located on or within the candle that are adapted to control these or other functionalities.

In addition to home lighting, lighting devices of the present disclosure may include, but are not limited to, lanterns, wishing lights, torches, fireplaces, outdoor lighting, wall lighting, flashlights, street lights or lanterns, or any other product. The LED display surface may form a dynamic effect (such as flame burning), the LEDs may be all lit, the LEDs may be partially lit, or any combination thereof may be used to form any desired lighting effect. As mentioned herein, the LED display may further adopt colorful LEDs to better simulate a true-flame and/or to give colored lighting to other lighting products.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. An electric flameless light, comprising:
a body configured in size and shape to simulate a true flame candle;
a light source operably connected to the body and positioned to be generally protruding from an exterior surface of the body, the light source comprising of a plurality of LED lights on a panel, the plurality of LED lights electrically operated to illuminate in a way that simulates the movement of a real candle's flame; and
controller circuitry electrically coupled to the light source to independently control the plurality of LED lights in different groups and independently control a single LED light within a given group separate from the given group.

2. The electric flameless light of claim 1, wherein the light source receives a digital signal varying in at least one of amplitude, frequency, and duty cycle.

3. The electric flameless light of claim 2, wherein the digital signal forms part of a pulse-width modulation signal.

4. The electric flameless light of claim 1, further comprising a lifting mechanism configured to change the relative position of the light source, wherein at least one position of the light source is generally protruding from an exterior surface of the body.

5. The electric flameless light of claim 4, wherein the lifting mechanism is at least one of a rack and pinion system, a spring-loaded system, and a hydraulic pump.

6. The electric flameless light of claim 1, wherein the plurality of LED lights on the panel are arranged on one side of the panel.

7. The electric flameless light of claim 6, further comprising the plurality of LED lights arranged on a second side of the panel.

8. The electric flameless light of claim 6, wherein the plurality of LED lights on the panel are arranged in the different groups as a matrix of rows and columns.

9. The electric flameless light of claim 1, further comprising a second light source located within the body and electrically operated to illuminate in a way that simulates the movement of a real candle's flame.

10. The electric flameless light of claim 1, further comprising a sensor configured to sense air movement, wherein the plurality of illuminators illuminate in a way to simulate being affected by the air movement.

11. The electric flameless light of claim 1, wherein the panel comprising a plurality of LED lights is rectangular in shape.

12. The electric flameless light of claim 1, wherein the panel comprising a plurality of LED lights is generally irregularly shaped.

13. An electric flameless light, comprising:
a base operably configured to screw into a light bulb socket;
a light source operably connected to the base, the light source comprising a plurality of illuminators arranged on a panel in a grid, each illuminator electrically operated to illuminate;
a cover surrounding the light source, the cover having at least semi-translucence; and
controller circuitry electrically coupled to the light source to control the plurality of illuminators independently to simulate an image of a flame by at least one of (1) dimming and fading-out or (2) brightening and fading-in different ones of the plurality of illuminators.

14. The electric flameless light of claim 13, wherein the plurality of illuminators may collectively illuminate to simulate a true flame.

15. The electric flameless light of claim 13, wherein the plurality of illuminators emit different colors of light.

16. The electric flameless light of claim 13, wherein each illuminator receives an individually randomized digital signal.

17. The electric flameless light of claim 13, wherein the plurality of illuminators are further arranged on a second grid, the second grid located on an opposite side of the panel.

18. The electric flameless light of claim 13, wherein the panel comprising a plurality of illuminators is rectangular in shape.

19. The electric flameless light of claim 13, wherein the panel comprising a plurality of illuminators is generally irregularly shaped.

20. An electric flameless light, comprising;
a printed circuit board comprising of a plurality of LEDs, the plurality of LEDs configured in a first grid on a first side of the printed circuit board, the grid having at least two rows and at least two columns, the plurality of LEDs electrically connected to receive a driving signal, the plurality of LEDs electrically operated to illuminate in a way that simulates the movement of a real candle's flame; and
controller circuitry electrically coupled to the light source to supply the driving signal to independently control the plurality of LEDs in different groups and independently control a single LED within a given group separate from the given group.

21. The electric flameless light of claim 20, wherein the panel is operably connected to a base, the base configured to screw into a light bulb socket.

22. The electric flameless light of claim 20, wherein the plurality of LEDs are further configured on a second grid on a second side of the printed circuit board.

23. The electric flameless light of claim 20, wherein an LED on the first grid corresponds electrically to an LED on the second grid.

24. The electric flameless light of claim 1, wherein the controller circuitry includes multiple microcontroller units.

25. The electric flameless light of claim 1, wherein the controller circuitry electrically is configured to varying an amount of power applied to the different groups independent of one another.

26. The electric flameless light of claim 8, wherein the controller circuitry is configured to independently control power delivered to different rows and columns.

27. The electric flameless light of claim 1, wherein each group includes at least 16 LED lights.

28. The electric flameless light of claim 1, wherein the LED lights are arranged on the panel at an angle with respect to the exterior surface.

29. The electric flameless light of claim 4, wherein the controller circuitry is configured to activate the display panel responsive to the lifting mechanism changing the relative position of the light source to be generally protruding from the exterior surface of the body.

30. The electric flameless light of claim 1, wherein the controller is integrated with the panel.
